(19) United States
(12) Patent Application Publication
(10) Pub. No.: US 2010/0151089 A1
(43) Pub. Date: Jun. 17, 2010

(54) Unblanched frozen vegetables

(76) Inventor: Dennis Arthur Lonergan, Long Lake, MN (US)

Correspondence Address: WESTMAN CHAMPLIN & KELLY, P.A., SUITE 1400, 900 SECOND AVENUE SOUTH, MINNEAPOLIS, MN, 55402, US

(21) Appl. No.: 12/336,778

(22) Filed: Dec. 17, 2008

(51) Int. Cl. A23B 7/154; B65B 55/00

(52) U.S. Cl. 426/106; 426/393; 426/324

(57) ABSTRACT

An improved method of freezing vegetables is disclosed in the present invention that eliminates the step of blanching vegetables prior to freezing. The method includes depleting headspace oxygen and oxygen within the plant tissue. The oxygen in the package is depleted by allowing the vegetables to respire for a period of time prior to freezing the vegetables. Frozen vegetable packages depleted of headspace oxygen and internal oxygen are also included in the present invention.

### BACKGROUND OF THE INVENTION

It has been recognized since the 1930's that it is necessary to inactivate enzymes in vegetables prior to freezing and frozen storage. This has been very effectively accomplished by “blanching”. Blanching involves heating the produce to between about 200° F.-212° F. for approximately 2 to 4 minutes. The produce can be heated with hot water, steam, or more recently microwave energy. Failure to inactivate enzymes such as lipoxygenase (Williams et. al. 1986) leads to oxidation and the development of significant off-flavors as well as degradation of the color of produce. This deterioration is fairly rapid, with significant changes developing within several weeks and progressively worsening over further frozen storage.

Although blanching is very effective at inactivating enzymes and thus preventing the formation of off-flavors, it has two large drawbacks. These are related to product quality and energy use. The quality of vegetables can be negatively affected by blanching because blanching is a rather severe heat treatment that partially or significantly cooks the vegetables prior to freezing. This affects the texture and causes a loss of turgidity (crispness). This is especially evident in certain vegetables, such as asparagus. In asparagus, the problem is so severe that frozen whole asparagus are generally not marketed at retail in the US. The product is so fragile after blanching that it can not stand up to further processing. The loss of turgidity is further exacerbated by the fact that blanching replaces air in the vegetable tissue with water. This water then turns to ice during the subsequent freezing process and these ice crystals cause further structural damage.

Thus, although it is widely recognized that frozen vegetables are less crisp that their fresh counterparts, this is in fact due as much or more to the blanching step than it is to freezing. From an environmental and energy usage perspective, it is wasteful in that the product is heated to near 212° F. just prior to freezing.

For the past 60 years or so, anyone involved in freezing of vegetables (industrially or at home) assumed the need to blanch prior to freezing. Birnbaum et al (1979) attempted to replace blanching with vacuum packaging but their efforts proved unsuccessful. They noted that “Blanched vegetables were rated higher than unblanched samples for visual quality, aroma, flavor and overall acceptability.”

### SUMMARY OF THE INVENTION

In one aspect, the present invention includes a package containing frozen vegetables. The invention includes a package component comprising package walls being impermeable to oxygen and the frozen vegetables being within the package component. The frozen vegetables are substantially free of total oxygen within the package component, and dissolved oxygen and entrained oxygen within the vegetables.

In another aspect, the present invention includes a method of freezing vegetables. The method includes depleting substantially all of the total oxygen in a package wherein the total oxygen comprises headspace oxygen, dissolved oxygen and entrained oxygen and freezing the package.

In yet another aspect, the present invention includes a method of storing vegetables. The method includes placing vegetables in an oxygen impermeable package and depleting substantially all of the total oxygen in the package wherein the total oxygen includes headspace oxygen, dissolved oxygen and entrained oxygen. The method also includes freezing the vegetables within the oxygen impermeable package.

### BRIEF DESCRIPTION OF THE DRAWINGS

FIG. 1 is a perspective view of the package of this invention.

FIG. 2 is a plot of the oxygen depletion.

FIG. 3 is a plot showing the rate of oxygen reduction.

FIG. 4 is a Lineweaver-Burke plot of the data from FIG. 3.

### DETAILED DESCRIPTION OF ILLUSTRATIVE EMBODIMENTS

The present invention includes an improved method for freezing vegetables. The method involves depleting substantially all of the oxygen around and within the vegetables to be frozen. Advantageously, this method eliminates the need for blanching the vegetables prior to freezing. The vegetables frozen according to the method remain crisp and show superior color, flavor, and aroma.

The improved method for freezing generally includes eliminating and/or minimizing oxygen that is in contact with the vegetables to be frozen. This includes oxygen that is present on the vegetables' exterior, as well as, the oxygen present on the vegetables' interior. The prior art methods have been based on inactivating enzymes that cause degradation by heat, i.e. blanching. The present invention is based on the depletion of oxygen from the vegetables, thus targeting and inactivating enzymes that require oxygen.

Generally, vegetables are in contact with three sources of oxygen. First, vegetables can be exposed to the oxygen in the environment. In a package of vegetables, the oxygen in the environment is the oxygen found in the headspace and referred to herein as headspace oxygen. Second, there can be oxygen dissolved in the water within the tissue of the vegetables, referred to herein as dissolved oxygen. Third, there can be oxygen in the air present within the tissue structure of the vegetables referred to herein as entrained oxygen. Internal oxygen as referred to herein includes both dissolved oxygen and entrained oxygen.

The present invention generally includes depleting the headspace oxygen and internal oxygen before freezing vegetables. Prior to freezing a package of vegetables, it is preferable to reduce the headspace by, for example, vacuum packaging in order to deplete the headspace oxygen. Preferably, the vegetables are stored in a film that does not allow the re-introduction of oxygen. Next, the internal oxygen of the vegetables is depleted. A novel means of depleting the internal oxygen is by allowing the vegetables to respire for a period of time after reducing the headspace but prior to freezing. The time required for respiration can be determined by calculating the amount of oxygen (headspace, dissolved and entrained oxygen) present in a vegetable package and the rate of respiration of the vegetables as described in detail below.

The process of the present invention can be used to store different kinds of vegetables. Vegetables can be cruciferous vegetables, leafy vegetables, root vegetables, pod vegetables, stem vegetables and the like. Pod vegetables are vegetables in which the pod is generally eaten by humans. Stem vegetables are vegetables in which the stem is generally eaten by humans. Suitable vegetables for the process include, for example, beans, asparagus, peas, broccoli, cauliflower, spinach and the like. The vegetables may be whole vegetables. Alternatively, the vegetables may be cut into smaller pieces. A package may contain only one type of vegetable. Alternatively, a package may contain more than one vegetable type.

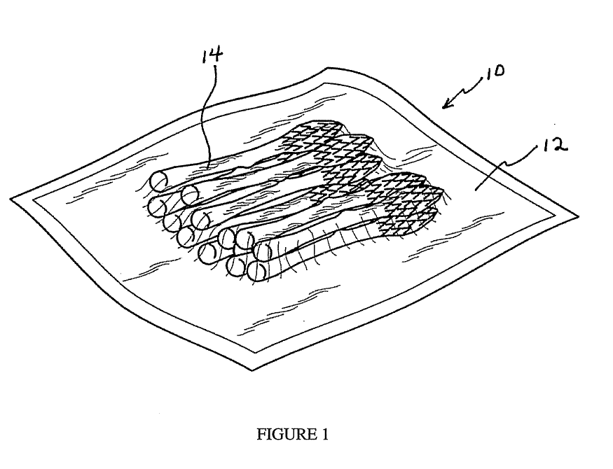

The vegetables 14 to be frozen are generally placed in a container indicated at 10 in FIG. 1. The container can be made from a variety of materials. The container walls, preferably are oxygen impermeable. In other words, the container does not allow the re-entry of oxygen once oxygen has been removed. The container may be a hard plastic container, a metal container, a Styrofoam container, and a flexible plastic film container such as a bag and the like. In preferred embodiments, the container is a plastic film package that is oxygen impermeable.

The headspace 12 in the vegetable container is generally reduced to substantially deplete the oxygen in the vegetable environment. Preferably, the headspace in the container is depleted of oxygen by the use of vacuum packaging. Vacuum packaging of vegetables is well known in the art and is performed using a variety of vacuum packaging equipment.

It is preferable to minimize the amount of headspace in the package to minimize the amount of oxygen thereby minimizing the length of time that the vegetables need to respire prior to freezing. Minimizing headspace can also minimize product dehydration during frozen storage. Preferably, the package headspace is reduced to less than 10 cc/100 grams of product. More preferably, the package headspace is reduced to less than 5 cc/100 grams of product. Most preferably, the package headspace is reduced to less than 1 cc/100 grams of product. The calculation of the amount of headspace in a package can be determined in variety of ways and one method is exemplified in Example 1 below.

After reducing the headspace, any remaining oxygen in the headspace and the internal oxygen is depleted and/or removed so that the vegetables are substantially free from exposure to oxygen. The oxygen may be depleted in a package of vegetables by allowing the vegetables to respire for a period of time to allow the oxygen to be consumed. The oxygen may also be depleted by the addition of enzymes that consume oxygen. Glucose oxidase is an exemplary enzyme that may be incorporated into a package of vegetables to deplete oxygen. Any methods that can deplete headspace oxygen and internal oxygen are within the scope of this invention.

In preferred embodiments, the vegetables are generally allowed to respire for a period of time prior to freezing. The respiration time varies and can be dependent, for example, on the specific vegetables in a package, the amount of vegetables in a package and the amount of headspace in a package. The respiration time can be calculated for a package of vegetables by determining the amount of headspace oxygen and internal oxygen present and dividing that number by the respiration rate of the particular vegetables in the package.

The rate of respiration of vegetables can be determined using published values. Table 1 provides some of the known respiration rates for common vegetables found in “Comprehensive Reviews in Food Science and Food Safety” Ch. 4 by J. N. Faber et al. Vol. 2 (supplement) 2003.

TABLE 1

| | Respiration Rate |
|---|---|
| Vegetable | (at 5° C., mg CO₂/kg/h) |
| Artichoke | — |
| Asparagus | >60 |
| Beans, snap | 40-60 |
| Broccoli | >60 |
| Brussels sprouts | 40-60 |
| Cabbage | 10-20 |
| Carrot | 10-20 |
| Cauliflower | 20-40 |
| Chili peppers | 10-20 |
| Corn, sweet | >60 |
| Cucumber | 4^{b} |
| Lettuce (leaf) | 10-20 |
| Mushrooms | >60 |
| Bell peppers | 10-20 |
| Spinach | >60 |
| Tomatoes (mature) | 10-20 |
| Tomatoes (partly ripe) | 10-20 |
| Potato | 5-10 |
| Onion | 5-10 |

The values for plant respiration are given in units of mg CO₂/kg-hr. This is multiplied by 0.73 to convert it to mg O₂ consumed. For example, the value for snap beans is ˜50 mg CO₂/kg-hr. (36 mg O₂/kg-hr) and for asparagus it is “greater than 60 mg CO₂/kg-hr”. (>44 mg O₂/kg-hr).

Alternatively, the respiration rate for a particular vegetable or vegetables may be experimentally determined. Experimental determination of the respiratory rate may provide a more accurate respiration rate because it can take into account the fact that the rate of oxygen depletion changes as the amount of oxygen decreases in the package. Determination of the respiration rate using this method, thus, may provide a more accurate respiration time than using the published respiration rate values. One method of experimentally determined respiration rate is exemplified below in Example 4.

Experimentally determined respiration rates generally indicate that the respiration time for a package of vegetables should be longer than the respiration time calculated based on the published respiration rate values. This increase in respiration time takes into account the changes in reaction rate as the reaction progresses. The use of respiration rates determined experimentally and/or from the published literature for determining the respiration times are within the scope of this invention.

In preferred embodiments, the respiration time for a package of vegetables is increased by between about an additional 20 percent and about an additional 40 percent from the respiration time calculated using the published respiration rates. In more preferred embodiments, the respiration time for a package of vegetables is increased by about an additional 30 percent from the respiration time calculated using the published respiration rates.

The total amount of oxygen to be removed from a package of vegetables can be calculated by first determining the amount of oxygen in the headspace, the amount of dissolved oxygen and the amount of entrained oxygen. These three sources of oxygen are determined and added together to determine the total oxygen to be removed. The amount of oxygen in the headspace, the amount of dissolved oxygen and the amount of entrained oxygen can be calculated for a given package of vegetables as described in detail in Examples 1-3 below.

The respiration time for 100 grams of vegetables can vary and is generally at least about 30 minutes. The specific vegetables and process variables such as the temperature can affect the respiration time.

Respiration of the vegetables can deplete a substantial amount of the total oxygen in the package. The vegetables can be frozen when a substantial amount of the oxygen is depleted from the package. Vegetables can be frozen when respiration generally depletes at least about 60 percent of the total oxygen in the package. Preferably, respiration depletes at least about 80 percent of the total oxygen in the package and more preferably, respiration depletes at least about 95 percent of the total oxygen in the package prior to freezing. Vegetables substantially depleted of the total oxygen may be frozen by any of the known techniques in the art. The vegetables preferably are stored at a temperature below at least about −10° C. and more preferably, below at least about −15° C.

In some embodiments, total oxygen may be depleted by addition of oxygen depleting agents. Oxygen depleting agents can include, for example, enzymes. An enzyme that can function as an oxygen depleting agent is glucose oxidase and thus, in one exemplary embodiment, glucose oxidase may be added to a package of vegetables.

In alternative embodiments, total oxygen may substantially be depleted by a combination of respiration and by the addition of an oxygen depleting agent. The combination of respiration with the inclusion of an oxygen depleting agent may be used to substantially deplete the total oxygen in a vegetable package.

The present invention includes vegetable packages that have been substantially depleted of oxygen. The vegetables in the package are substantially depleted of the oxygen in the headspace, the dissolved oxygen and the entrained oxygen. The vegetable package may, in some embodiments, include agents that deplete oxygen. Oxygen depleting agents can be, for example, oxygen scavenging enzymes such as glucose peroxidase and iron compositions that oxidize to ferric state. Other oxygen depleting agents are also within the scope of the invention.

The frozen vegetable packages can include any of the vegetables described above. The frozen vegetable packages may also include a mixture of one or more of the vegetables. The vegetables are preferably packaged in a container that is impermeable to oxygen. The size of the vegetable package can vary. Any of the sizes generally available in the art can be produced using the process of the present invention.

The present invention also includes a method of depleting oxygen from vegetables. The vegetables can be placed in a package, preferably a package that is impermeable to oxygen. In preferred embodiments, the headspace in the package can be reduced, for example, by vacuum packaging. The total oxygen in the package can then be substantially depleted. Oxygen depletion can be performed by allowing the vegetables to respire. Alternatively, oxygen depletion can include addition of one or more oxygen depleting agents. Oxygen depleting agents can be enzymes, such as glucose oxidase. After depletion of the oxygen, the vegetable package may be frozen.

The present invention also includes a method of storing vegetables. The vegetables can be placed in a package, preferably a package that is impermeable to oxygen. In preferred embodiments, the headspace in the package can be reduced, for example, by vacuum packaging. The total oxygen in the package can then be substantially depleted. Oxygen depletion can be performed by allowing the vegetables to respire. Alternatively, oxygen depletion can include addition of one or more oxygen depleting agents. Oxygen depleting agents can be enzymes, such as glucose oxidase. After depletion of the oxygen, the vegetable package may be frozen.

### EXAMPLES

### Example 1

### Calculation of the Amount of Oxygen to be Removed by Plant Respiration

This example illustrates a method of calculation to determine the amount of total oxygen in a package of vegetables. The following values are generally known and accepted in the art:

Air contains approximately 21% oxygen by volume at ambient temperature and pressure.

The density of air is 1.24 mg/ml at standard conditions The solubility of oxygen in water at 5° C. is approximately 12.8 mg/l.

The density of water is 1 g/ml 1. Archimedes' Principle can be used to determine the headspace. In this method, a package of vegetables is submerged in a beaker of water with a known weight. The combined weight of the vegetables, the package and the headspace can be determined by the difference in weight between the beaker of water and the beaker of water with the package and referred to as W1. In a second measurement, the vegetables are removed from the package. The vegetables and the package material are submerged in a beaker of water with a known weight. The difference in weight between the package and vegetables in the beaker of water and just the beaker of water is referred to as W2. Calculation of W1-W2 provides the volume of the headspace.

The amount of oxygen in the headspace of the package can be estimated by multiplying the volume of the package headspace by 21%.

2. The amount of oxygen dissolved in the water within the vegetables is calculated by multiplying the amount of water in the vegetables by 12.8 mg/l. The water content of a given vegetable is known in the art and can be found for example in USDA National Nutrient Database for Standard Reference, Release 20.

3. The amount of entrained air in the vegetable material can be calculated by measuring the density of the vegetable by a water displacement method and estimating its solids content, and assuming that those solids have a density of 1.1 gr./cc (0.91 cc/gr). The amount of oxygen is then calculated by multiplying this volume by 21%.

The amount of oxygen from step #1, #2 and #3 are added together to obtain the total oxygen to be removed from the package. The total oxygen is divided by the respiration rate of the vegetable to determine the length of the respiration period. After this respiration period, the vegetables may be frozen.

### Example 2

### Freezing Snap Beans

### Calculation of Respiration Time for Snap Beans:

The respiration time needed to deplete O₂ from vacuum packaged 100 grams of snap beans was calculated. Snap beans were estimated to be about 10% solids, thus about 10 grams of solids in a package of 100 g of beans. 10 grams of solids have an estimated volume of 9.1 cm³. The density of beans have been measured to be 0.93 g/cm³. (1.07 cm³/g). The headspace in the package is estimated to be about 2.9 cm³.

The amount of total O₂ to be depleted by respiration was calculated. In a 100 g package of beans, since 10% is solids the other 90% (90 g) is water.

### Headspace Oxygen:

There was 2.9 cm³ of air in the headspace, thus

(2.9 cm³×1.24 mg/cm³)×(0.21)=0.76 mg O₂ in the package headspace

### Dissolved Oxygen:

(90 g of water)×(12.8 mg 02/1000 g of water)=1.15 mg of O₂ dissolved in the water component of the beans.

### Oxygen in Entrained Air:

(107^{a} cm³−(₉₀^{b} cm³+9.1^{c} cm³)=7.9 cm³ air

^{a}vol. of 100 g beans; ^{b} vol. of 90 g water in beans; ^{c} vol. of 10 g of solids

(7.9 cm³×1.24 mg/cm³)×(0.21)=2.4 mg O₂ in the entrained air in the beans.
Total oxygen in the package=0.76+1.15+2.4=4.31 mg O₂
Rate of O₂ depletion by snap bean respiration: 3.6 mg O₂/100 g−hr
The estimated time to deplete O₂=4.31/3.6=1.2 hrs (72 minutes).
Procedure and Results:

Fresh snap beans were vacuum packaged (100 grams per bag) and held at 4° C. for 69 minutes to deplete the oxygen in the sample. The beans were then frozen and stored at −18° C. Control blanched snap beans were prepared by blanching fresh snap beans in boiling water for 3 minutes. The beans were then cooled in ice water for 10 minutes, packaged, frozen and stored at −18° C.

Beans were evaluated after 3, 6 and 12 weeks of storage at −18° C. At each evaluation time the samples were heated in a 700 W MW oven for 2 min or for 90 seconds in a 1000 W MW oven. A freshly frozen (2 hr @−18° C.) sample of snap beans was also prepared for each evaluation.

The un-blanched, O₂ depleted samples were considerably crisper than the blanched samples at all evaluations. The un-blanched, O₂ depleted samples showed no off-flavor development and no changes in flavor, aroma or color over the 12 week period. At each evaluation they were very similar to the freshly frozen reference sample.

### Example 3

### Freezing Asparagus

### Calculation of Respiration Time for Asparagus:

The respiration time needed to deplete O₂ from vacuum packaged 100 grams of asparagus was calculated. Asparagus were estimated to be about 7.8% solids, thus about 7.8 grams of solids in a package of 100 g of asparagus. Using an average figure of 1.1 grams/cm³ as the density of the solids in food materials, this 7.8 grams of solids have an estimated volume of 7.1 cm³. The solids content of vegetables was obtained from USDA National Nutrient Database for Standard Reference, Release 20. The density of asparagus has been measured to be 0.94 g/cm³. (1.07 cm³/g). The headspace in the package is estimated to be about 2.4 cm³.

The amount of total O₂ to be depleted by respiration was calculated. In a 100 g package of asparagus, since 7.8% is solids the other 92.2% (92.2 g) is estimated to be water.

### Headspace Oxygen:

There was 2.4 cm³ of air in the headspace, thus

(2.4 cm³×1.24 mg/cm³)×(0.21)=0.62 mg O₂ in the package headspace

### Dissolved Oxygen:

(92.2 g of water)×(12.8 mg O₂/1000 g of water)=1.18 mg of O₂ dissolved in the water component of the asparagus.

### Oxygen in the Entrained Air:

(107^{a} cm³−(92.2^{b} cm³+7.1^{c} cm³)=7.7 cm³ air

(^{a} vol. of 100 g asparagus; ^{b} vol. of 92.8 g water in asparagus; ^{c} vol. of 7.2 g of solids)

^{a} vol. of 100 g beans; ^{b} vol. of 90 g water in beans; ^{c} vol. of 10 g of solids

(7.7 cm³×1.24 mg/cm³)×(0.21)=2.0 mg O₂ in the entrained air in the asparagus.

Total oxygen in the package=0.62+1.18+2.0=3.8 mg O₂

Rate of O₂ depletion by asparagus respiration: 4.4 mg O₂/100 g −hr

The estimated time to deplete O₂=3.8/4.4=0.86 hrs (52 minutes).

### Procedure and Results:

Fresh asparagus was vacuum packaged (100 grams per bag) and held at 4° C. for 52 minutes to deplete the oxygen in the sample. The asparagus was then frozen and stored at −18 C. Control blanched asparagus was prepared by blanching fresh asparagus in boiling water for 3 minutes. The asparagus was then cooled in ice water for 10 minutes, packaged, frozen and stored at −18° C.

Asparagus was evaluated after 3, 6, 10 and 27 weeks of storage at −18° C. At each evaluation time the samples were heated in a 700 W MW oven for 2 min or for 90 seconds in a 1000 W MW oven. A freshly frozen (2 hr @−18° C.) sample of asparagus was also prepared for each evaluation.

The un-blanched and O₂ depleted sample were considerably crisper than the blanched samples at all evaluations. The un-blanched and O₂ depleted sample showed no off-flavor development and no changes in flavor, aroma or color over the 27 week period. At each evaluation they were very similar to the freshly frozen reference sample.

### Example 4

### Determination of Respiration Rate

### Procedure and Results:

Fresh asparagus (212 grams) was placed in a jar. The headspace in the jar was 219 cm³. The jar was wrapped in aluminum foil to exclude light and thus prevent photosynthesis. An oxygen sensor was fitted to the lid of the container. The level of oxygen in the container was monitored until it reached zero percent oxygen.

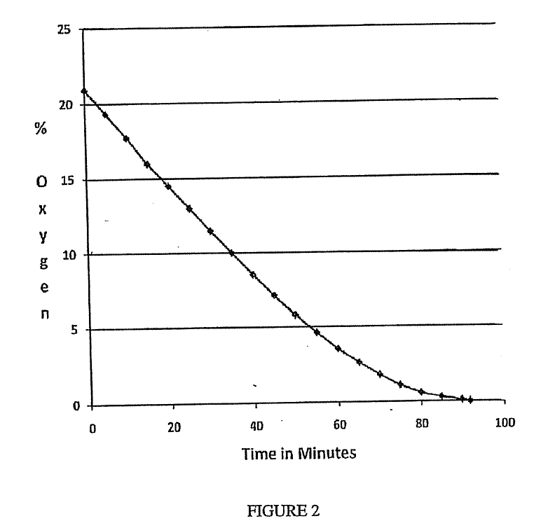

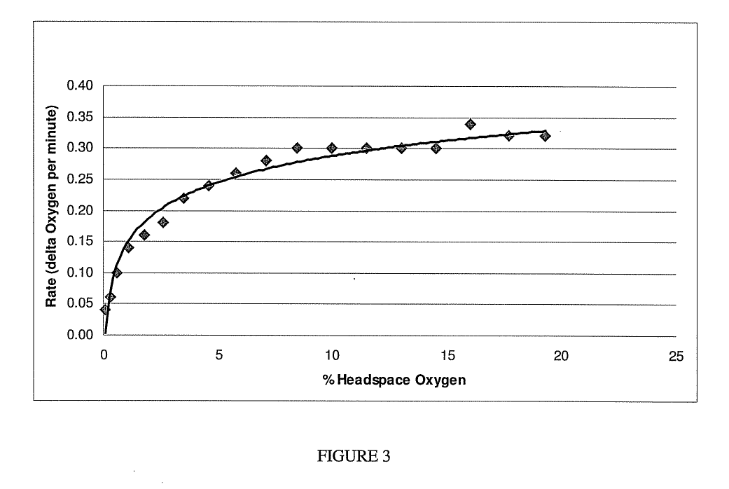

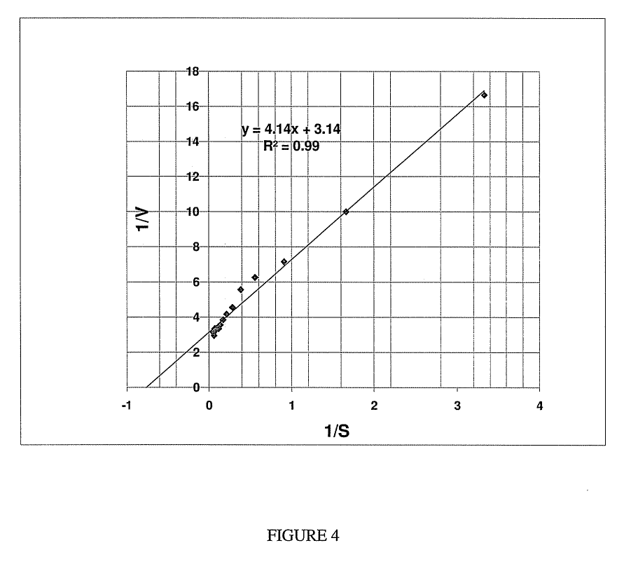

The results are shown in FIG. 2 as an oxygen depletion curve with the oxygen percentage in the headspace plotted against time. The rate of oxygen reduction was calculated and shown in FIG. 3. A Lineweaver-Burke plot of the reaction is shown in FIG. 4. In this type of plot, the reduction of reaction rate is a function of the concentration of the reactant (oxygen). Typically, one would expect the build-up of the end product of the reaction to also cause a reduction in the rate of the reaction. It is standard practice to generate data on enzyme reaction rates in pure systems, and over very short time periods. This is to remove the effect of end product inhibition of the reaction. In the experiment described here all of the carbon dioxide produced in the reaction was allowed to accumulate in the system. The fact that the oxygen depletion rate data fits this mathematical treatment so well indicates that there is no significant end product (carbon dioxide) inhibition of the reaction. From an enzyme reaction kinetics standpoint, this result was unexpected.

This analysis indicated that the respiration time allowed for a package of vegetables should be approximately 30 percent more than the respiration time calculated using the published respiration rate values. This results in minimizing the oxygen concentration in the package to about zero.

For the snap beans in Example 2, the respiration time can be increased from about 72 minutes to about 94 minutes.

72 minutes +(72×0.30)=93.6 minutes

For the asparagus in Example 3, the respiration time can be increased from about 52 minutes to about 68 minutes.

52 minutes +(52×0.30)=67.6 minutes

Although the present invention has been described with reference to preferred embodiments, workers skilled in the art will recognize that changes may be made in form and detail without departing from the spirit and scope of the invention.

What is claimed is:

1. A package containing frozen vegetables comprising:
a package component comprising package walls being impermeable to oxygen; and
the frozen vegetables being within the package component, the frozen vegetables substantially free of total oxygen within the package component, and dissolved oxygen and entrained oxygen within the vegetables.

2. The package of claim 1 wherein the frozen vegetables are snap beans.

3. The package of claim 1 wherein the frozen vegetables are asparagus.

4. The package of claim 1 wherein the frozen vegetables comprise more than one type of vegetable.

5. The package of claim 1 further comprising an oxygen depleting agent.

6. The package of claim 1 wherein the oxygen depleting agent is an oxygen scavenging enzyme.

7. The package of claim 1 further comprising glucose oxidase.

8. A method of freezing vegetables comprising:
depleting substantially all of the total oxygen in a package wherein the total oxygen comprises headspace oxygen, dissolved oxygen and entrained oxygen; and
freezing the package.

9. The method of claim 8 wherein the depleting is performed by allowing the vegetables to respire for a selected time period prior to freezing.

10. The method of claim 9 wherein the headspace oxygen is reduced by vacuum packaging prior to respiration.

11. The method of claim 9 wherein the selected time period is at least 30 minutes.

12. The method of claim 8 wherein the vegetables are snap beans.

13. The method of claim 8 wherein the vegetables are asparagus.

14. The method of claim 8 wherein the package comprises film walls that are oxygen impermeable.

15. The method of claim 8 wherein respiration depletes at least 70 percent of the total oxygen present prior to freezing.

16. The method of claim 8 wherein respiration depletes at least 90 percent of the total oxygen present prior to freezing.

17. The method of claim 8 wherein the depleting is performed by the addition of an oxygen scavenging enzyme.

18. The method of claim 17 wherein the enzyme is glucose oxidase.

19. A method of storing vegetables comprising:
placing vegetables in an oxygen impermeable package;
depleting substantially all of the total oxygen in the package wherein the total oxygen includes headspace oxygen, dissolved oxygen and entrained oxygen; and
freezing the vegetables within the oxygen impermeable package.

20. The method of claim 19 wherein the depleting is performed by allowing the vegetables to respire for a selected period of time prior to freezing.

21. The method of claim 19 wherein the headspace oxygen is reduced by vacuum packaging prior to respiration.

22. The method of claim 19 wherein the vegetables are snap beans.

23. The method of claim 19 wherein the vegetables are asparagus.

24. The method of claim 19 wherein respiration depletes at least 70 percent of the total oxygen present prior to freezing.
